(19) United States
(12) Patent Application Publication
(10) Pub. No.: US 2012/0103959 A1
(43) Pub. Date: May 3, 2012

(54) AUXILIARY HEATING APPARATUS FOR VEHICLE

(75) Inventors: Myung Hoe Kim, Seoul (KR); Do Sik Min, Chungcheongbuk-do (KR); Kwang Hun Oh, Daejeon (KR)

(73) Assignees: Hyundai Motor Company, Seoul (KR); Halla Climate Control Corp., Daejeon-si (KR); Kia Motors Corporation, Seoul (KR)

(21) Appl. No.: 13/166,391

(22) Filed: Jun. 22, 2011

(30) Foreign Application Priority Data
Oct. 29, 2010 (KR) 10-2010-0107300

(51) Int. Cl. H05B 1/00

(52) U.S. Cl. 219/202

(57) ABSTRACT

An auxiliary heating apparatus for a vehicle may include a PTC (“Positive Temperature Coefficient”) heating module including a PTC element, and positive and negative terminal boards supplying power to the PTC element, the PTC heating module being disposed between coolant tubes of a heater core of an air conditioning system for the vehicle, a radiation fin provided on each of opposite sides of the PTC heating module to promote a radiation of heat of the PTC heating module, and a holding unit securing the PTC heating module to the coolant tubes.

### CROSS-REFERENCE TO RELATED APPLICATIONS

The present application claims priority to Korean Patent Application No. 10-2010-0107300 filed on Oct. 29, 2010, the entire contents of which is incorporated herein for purposes by this reference.

### BACKGROUND OF THE INVENTION

1. Field of the Invention

The present invention relates to an auxiliary heating apparatus for a vehicle, which is mounted between coolant tubes of a heater core without an additional holding device, thus aiding the air heating operation of the heater core.

2. Description of Related Art

Generally, a vehicle is constructed so that coolant that cools an engine is circulating, and that the coolant heated in the engine passes through a coolant tube of a heater core to heat air supplied to the interior of the vehicle, thus supplying warm air to the interior of the vehicle.

When the vehicle is first started, the temperature of the engine is low, so that it is impossible to immediately supply warm air through the heater core. Thus, in order to solve the problem, as shown in FIG. 1, a PTC heater 30 is additionally installed in an air conditioning system 1 for a vehicle to assist the functionality of a heater core 20.

However, such a structure is problematic in that a space for installing the additional auxiliary heating apparatus 30 is required, so that the size of the air conditioning system 1 is increased, and the heater core 20 and the auxiliary heating apparatus 30 have to be installed, so that the number of assembling processes increases and the manufacturing cost of a vehicle increases.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to propose an auxiliary heating apparatus for a vehicle, which is integrally assembled with a heater core of an air conditioning system for a vehicle without an additional holding device, so that the auxiliary heating apparatus can be installed without the necessity of changing the size of the air conditioning system, and which can reduce the number of assembling processes and the manufacturing cost.

In an aspect of the present invention, the auxiliary heating apparatus for a vehicle may include a PTC (“Positive Temperature Coefficient”) heating module including a PTC element, and positive and negative terminal boards supplying power to the PTC element, the PTC heating module being disposed between coolant tubes of a heater core of an air conditioning system for the vehicle, a radiation fin provided on each of opposite sides of the PTC heating module to promote a radiation of heat of the PTC heating module, and a holding unit securing the PTC heating module to the coolant tubes.

The PTC element, the positive terminal board, and the negative terminal board of the PTC heating module may be accommodated in one rod-type housing, and an insulating board may be provided in the rod-type housing between the rod-type housing and the positive terminal board and between the rod-type housing and the negative terminal board respectively to electrically insulate each of the positive and negative terminal boards from the rod-type housing.

A side surface of the upper holder and the radiation fin provided on each of the opposite sides of the PTC heating module may have a predetermined gap therebetween, thus allowing the predetermined gap to be present between the radiation fin and the corresponding coolant tube of the heater core.

The holding unit may include an upper holder having a guide slot to hold an upper end of the PTC heating module therein, and a locking step formed on each of opposite sides thereof, wherein the locking step may be locked to the corresponding coolant tube of the heater core, and an upper holder cap detachably fastened to the upper holder, wherein a width of the upper holder cap may be larger than a width of the upper holder to hold the coolant tubes of the heater core such that the upper holder cap and the locking step of the upper holder press the coolant tubes of the heater core therebetween when the upper holder cap may be fastened to the upper holder, thus securing the upper holder to the coolant tubes of the heater core.

The holding unit may further include a lower holder having a guide slot to hold a lower end of the PTC heating module, and a locking step formed on each of opposite sides thereof, wherein the locking step may be locked to the corresponding coolant tube of the heater core, and a lower holder cap detachably fastened to the lower holder, wherein a width of the lower holder cap may be larger than a width of the lower holder to hold the coolant tubes of the heater core such that the lower holder cap and the locking step of the lower holder press the coolant tubes of the heater core therebetween when the lower holder cap may be fastened to the lower holder, thus securing the lower holder to the coolant tubes of the heater core.

A side surface of the lower holder and the radiation fin provided on each of the opposite sides of the PTC heating module may have a predetermined gap therebetween, thus allowing the predetermined gap to be present between the radiation fin and the corresponding coolant tube of the heater core.

A rod cap may be mounted to the guide slot of the upper holder to separate or support the positive terminal board and the negative terminal board, a positive terminal pin may be provided on an end of the positive terminal board, a negative terminal pin may be provided on an end of the negative terminal board, and the positive terminal pin and the negative terminal pin may be connected, respectively, to a positive power line and a negative power line in the upper holder.

As is apparent from the above description, the auxiliary heating apparatus for the vehicle according to the present invention provides the advantage in that it is integrally assembled with the heater core of the air conditioning system for the vehicle without an additional holding device, so that the auxiliary heating apparatus can be installed without the necessity of changing the size of the air conditioning system, and it can reduce the number of assembling processes and the manufacturing cost.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view showing an air conditioning system for a vehicle equipped with a conventional auxiliary heating apparatus.

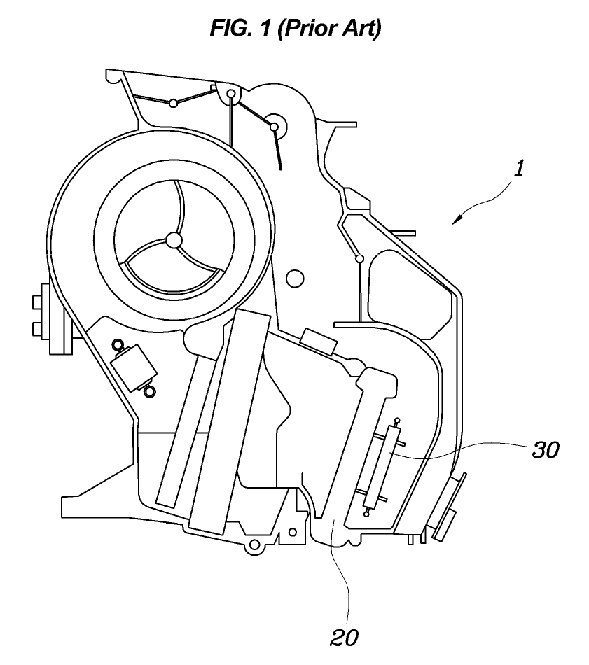

FIG. 2 is a view showing an air conditioning system for a vehicle equipped with an auxiliary heating apparatus according to an exemplary embodiment of the present invention.

FIG. 3 is a perspective view showing the auxiliary heating apparatus for the vehicle according to the exemplary embodiment of the present invention.

FIG. 4 is an exploded perspective view showing the construction of the auxiliary heating apparatus for the vehicle according to the exemplary embodiment of the present invention.

FIG. 5 is a view showing the assembling structure of the auxiliary heating apparatus for the vehicle according to the exemplary embodiment of the present invention.

FIG. 6 is a view showing the auxiliary heating apparatus for the vehicle according to the exemplary embodiment of the present invention which is installed in a heater core.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, the exemplary embodiment of the present invention will be described in detail with reference to the accompanying drawings.

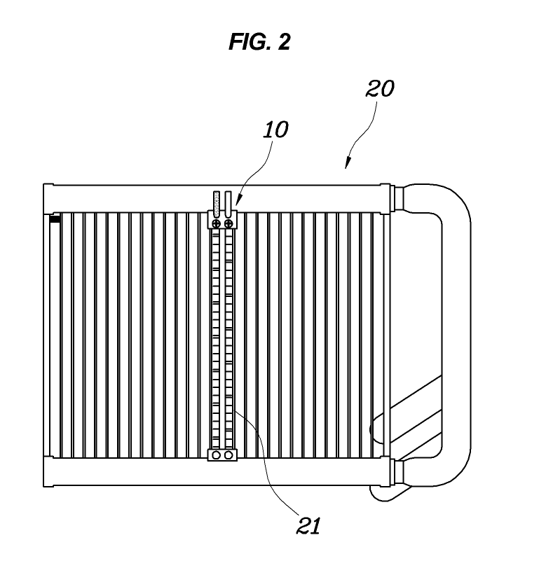

Referring to FIG. 2, an auxiliary heating apparatus 10 for a vehicle according to the exemplary embodiment of the present invention is installed in such a way as to be inserted into a space which is formed by removing one of coolant tubes 21 from a heater core 20, and the upper and lower parts of the apparatus 10 are supported by coolant tubes 21 which are provided on opposite sides of the apparatus 10.

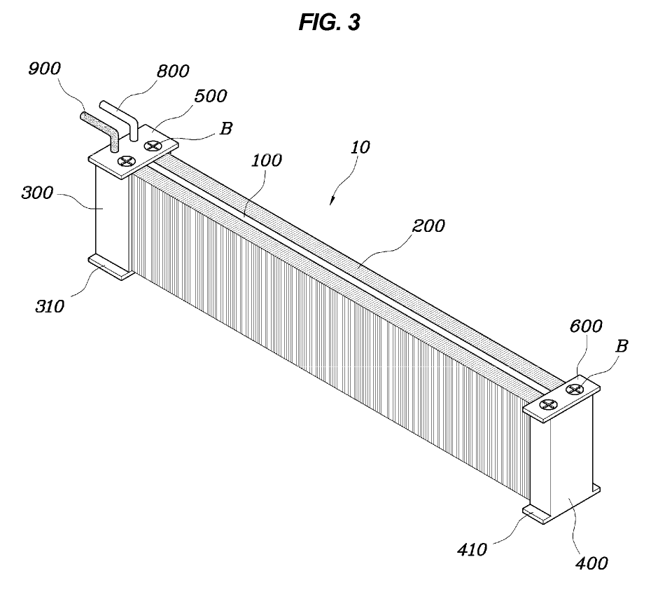

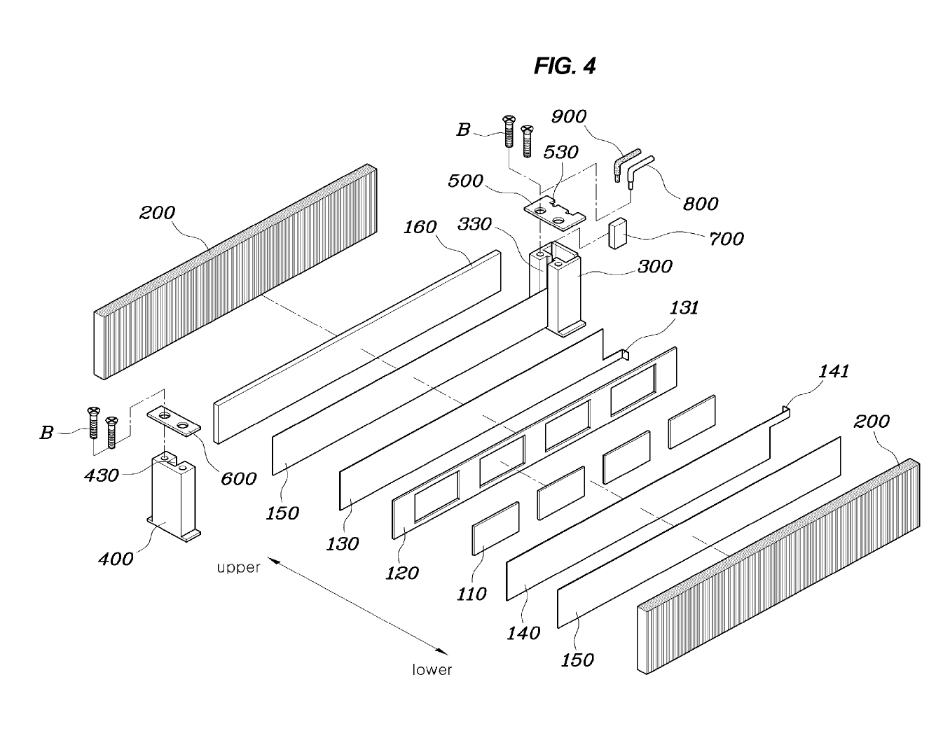

The construction of the auxiliary heating apparatus 10 for the vehicle will be described below in detail with reference to FIGS. 3 and 4.

Referring to FIGS. 3 and 4, the auxiliary heating apparatus 10 for the vehicle according to the exemplary embodiment of the present invention includes a PTC heating module 100, radiation fins 200, and a holding unit which secures the PTC heating module 100 to the coolant tubes 21.

The holding unit includes an upper holder 300 and an upper holder cap 500, and may further include a lower holder 400 and a lower holder cap 600.

The PTC heating module 100 includes PTC elements 110, a positive terminal board 130 and a negative terminal board 140 which supply power to the PTC elements 110. The PTC elements 110, the positive terminal board 130, and the negative terminal board 140 are supported by a support guide 120 and inserted into a rod-type housing 160 which is hollow therein.

Preferably, the rod-type housing 160 is made of an aluminum material which transfers heat well. Further, insulating boards 150 are preferably installed in the rod-type housing 160 to electrically insulate the rod-type housing 160 from the positive terminal board 130 and the negative terminal board 140.

The PTC elements 110, the positive terminal board 130, and the negative terminal board 140 constituting the PTC heating module 100 are integrally installed in the rod-type housing 160. Such a construction enables the PTC heating module 100 to maintain its original shape when the PTC heating module 100 is installed in the heater core 20, thus preventing the PTC heating module 100 from being deformed or damaged after it has been installed.

The radiation fins 200 are installed on opposite sides of the PTC heating module 100, thus promoting the heat radiation of the PTC heating module 100.

The upper holder 300 includes a guide slot 330 and functions to hold the upper end of the PTC heating module 100 in the guide slot 330 so that the PTC heating module 100 can be installed in the heater core 20. Locking steps 310 are provided on opposite sides of the upper holder 300, that is, right and left sides thereof, to be locked by the coolant tubes 21 of the heater core 20 which are provided on the right and left sides of the PTC heating module 100.

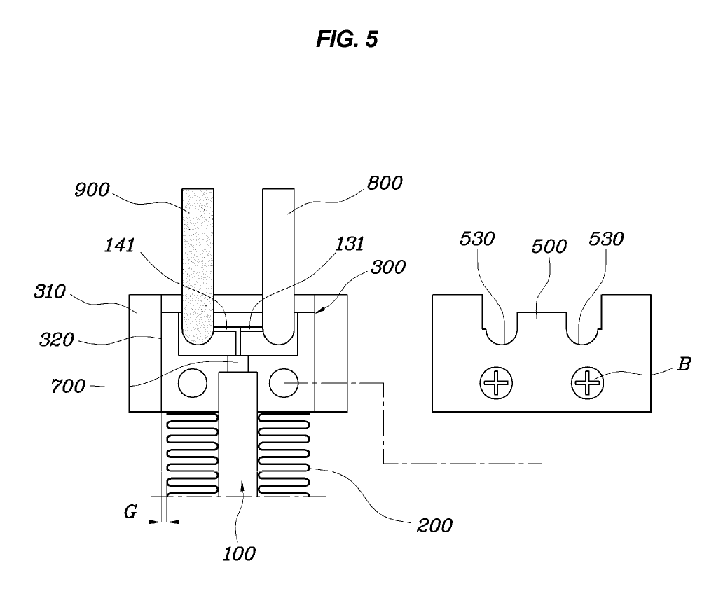

Meanwhile, as shown in FIG. 5, a rod cap 700 may be mounted to the guide slot 330 of the upper holder 300 to separate or support the positive terminal board 130 and the negative terminal board 140 therein. A positive terminal pin 131 and a negative terminal pin 141 are provided, respectively, on an end of the positive terminal board 130 and an end of the negative terminal board 140. The positive terminal pin 131 and the negative terminal pin 141 are connected, respectively, to a positive power line 800 and a negative power line 900 in the upper holder 300.

The upper holder cap 500 is fastened to the upper holder 300 with bolts B. The upper holder cap 500 fastened to the upper holder 300 serves to hold the positive power line 800 and the negative power line 900 connected to the positive terminal pin 131 and the negative terminal pin 141, respectively, without shaking. In an exemplary embodiment of the present invention, the upper holder cap 500 may include slots 530 into which the positive power line 800 and the negative power line 900 are inserted therein.

Further, a width of the upper holder cap 500 is larger than that of the upper holder 300 and presses the coolant tubes 21 of the heater core 20 along with the locking steps 310 of the upper holder 300, thus securing the upper holder 300 to the coolant tubes 21 of the heater core 20.

The lower holder 400 includes a guide slot 430 and functions to hold the lower end of the PTC heating module 100 in the guide slot 430 so that the PTC heating module 100 can be installed in the heater core 20. Locking steps 410 are provided on opposite sides of the lower holder 400, that is, right and left sides thereof, to be locked by the coolant tubes 21 of the heater core 20 which are provided on the right and left sides of the PTC heating module 100.

The lower holder cap 600 is fastened to the lower holder 400 with bolts B. A width of the lower holder cap 600 fastened to the lower holder 400 is larger than that of the lower holder 400 and presses the coolant tubes 21 of the heater core 20 along with the locking steps 410 of the lower holder 400, thus securing the lower holder 400 to the coolant tubes 21 of the heater core 20.

Meanwhile, referring to FIG. 5, each of the radiation fins 200 which are provided on opposite sides of the PTC heating module 100 is formed to have a size such that a predetermined gap G is defined between the radiation fin 200 and a corresponding side surface 320 of the upper holder 300. Although not shown in detail in the drawings, such a gap G is also formed between each radiation fin 200 and a corresponding side surface 440 of the lower holder 400.

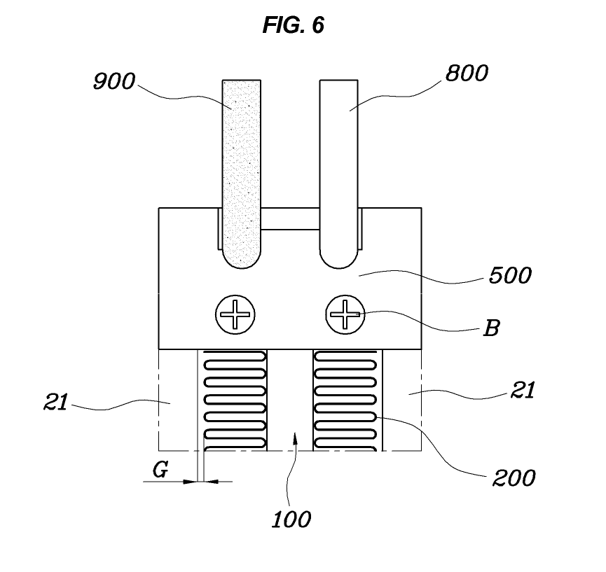

Thus, when the PTC heating module 100 is installed in the heater core 20 via the upper holder 300 and the lower holder 400, as shown in FIG. 6, the predetermined gap G is formed between each radiation fin 200 and the coolant tube 21 of the heater core 20.

As such, the predetermined gap G is formed between the coolant tube 21 of the heater core 20 and each radiation fin 200 to prevent the heat of the PTC heating module 100 from being wasted. That is, if the radiation fin 200 is in contact with the coolant tube 21 of the heater core 20, in the initial starting stage when the temperature of the heater core 20 is lower than that of the PTC heating module 100, heat generated from the PTC heating module 100 is not used to heat the air but is used to heat the coolant of the heater core 20. In this case, the loss of heat occurs.

When the auxiliary heating apparatus according to the exemplary embodiment of the present invention is applied to a vehicle, it is integrally assembled with the heater core of the air conditioning system for the vehicle without an additional holding device, so that it can be installed without the necessity of changing the size of the air conditioning system, and the number of assembling processes and the manufacturing cost can be reduced.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An auxiliary heating apparatus for a vehicle, comprising:
a PTC (“Positive Temperature Coefficient”) heating module including a PTC element, and positive and negative terminal boards supplying power to the PTC element, the PTC heating module being disposed between coolant tubes of a heater core of an air conditioning system for the vehicle;
a radiation fin provided on each of opposite sides of the PTC heating module to promote a radiation of heat of the PTC heating module; and
a holding unit securing the PTC heating module to the coolant tubes.

2. The auxiliary heating apparatus as set forth in claim 1, wherein the PTC element, the positive terminal board, and the negative terminal board of the PTC heating module are accommodated in one rod-type housing, and an insulating board is provided in the rod-type housing between the rod-type housing and the positive terminal board and between the rod-type housing and the negative terminal board respectively to electrically insulate each of the positive and negative terminal boards from the rod-type housing.

3. The auxiliary heating apparatus as set forth in claim 1, wherein a side surface of the upper holder and the radiation fin provided on each of the opposite sides of the PTC heating module have a predetermined gap therebetween, thus allowing the predetermined gap to be present between the radiation fin and the corresponding coolant tube of the heater core.

4. The auxiliary heating apparatus as set forth in claim 1, wherein the holding unit comprises:
an upper holder including:
a guide slot to hold an upper end of the PTC heating module therein; and
a locking step formed on each of opposite sides thereof, wherein the locking step is locked to the corresponding coolant tube of the heater core; and
an upper holder cap detachably fastened to the upper holder, wherein a width of the upper holder cap is larger than a width of the upper holder to hold the coolant tubes of the heater core such that the upper holder cap and the locking step of the upper holder press the coolant tubes of the heater core therebetween when the upper holder cap is fastened to the upper holder, thus securing the upper holder to the coolant tubes of the heater core.

5. The auxiliary heating apparatus as set forth in claim 4, wherein the PTC element, the positive terminal board, and the negative terminal board of the PTC heating module are accommodated in one rod-type housing, and an insulating board is provided in the rod-type housing to electrically insulate each of the positive and negative terminal boards from the rod-type housing.

6. The auxiliary heating apparatus as set forth in claim 4, wherein a side surface of the upper holder and the radiation fin provided on each of the opposite sides of the PTC heating module have a predetermined gap therebetween, thus allowing the predetermined gap to be present between the radiation fin and the corresponding coolant tube of the heater core.

7. The auxiliary heating apparatus as set forth in claim 4, wherein the holding unit comprises:
a lower holder having:
a guide slot to hold a lower end of the PTC heating module; and
a locking step formed on each of opposite sides thereof, wherein the locking step is locked to the corresponding coolant tube of the heater core; and
a lower holder cap detachably fastened to the lower holder, wherein a width of the lower holder cap is larger than a width of the lower holder to hold the coolant tubes of the heater core such that the lower holder cap and the locking step of the lower holder press the coolant tubes of the heater core therebetween when the lower holder cap is fastened to the lower holder, thus securing the lower holder to the coolant tubes of the heater core.

8. The auxiliary heating apparatus as set forth in claim 7, wherein the PTC element, the positive terminal board, and the negative terminal board of the PTC heating module are accommodated in one rod-type housing, and an insulating board is provided in the rod-type housing to electrically insulate each of the positive and negative terminal boards from the rod-type housing.

9. The auxiliary heating apparatus as set forth in claim 7, wherein a side surface of the upper holder and the radiation fin provided on each of the opposite sides of the PTC heating module have a predetermined gap therebetween, thus allowing the predetermined gap to be present between the radiation fin and the corresponding coolant tube of the heater core.

10. The auxiliary heating apparatus as set forth in claim 7, wherein a side surface of the lower holder and the radiation fin provided on each of the opposite sides of the PTC heating module have a predetermined gap therebetween, thus allowing the predetermined gap to be present between the radiation fin and the corresponding coolant tube of the heater core.

11. The auxiliary heating apparatus as set forth in claim 4, wherein a rod cap is mounted to the guide slot of the upper holder to separate or support the positive terminal board and the negative terminal board, a positive terminal pin is provided on an end of the positive terminal board, a negative terminal pin is provided on an end of the negative terminal board, and the positive terminal pin and the negative terminal pin are connected, respectively, to a positive power line and a negative power line in the upper holder.
